(19) United States
(12) Patent Application Publication
(10) Pub. No.: US 2012/0133849 A1
(43) Pub. Date: May 31, 2012

(54) DISPLAY STRUCTURE

(75) Inventor: Xunren Chen, Fuqing City (CN)

(73) Assignee: TPV ELECTRONICS (FUJIAN) CO., LTD., Fuqing City (CN)

(21) Appl. No.: 12/957,017

(22) Filed: Nov. 30, 2010

(51) Int. Cl. H04N 5/64

(52) U.S. Cl. 348/843; 348/E05.128

(57) ABSTRACT

A display structure comprising a rear casing, a circuit board, at least one connector and a labeling unit is provided. The rear casing is disposed at behind of the display structure. The circuit board is disposed at interior of the display structure. The connector connects to the circuit board. The labeling unit contains at least one fitting hole penetrating the labeling unit. The connector is corresponded to and located inside the fitting hole. Each fitting hole has a labeling figure disposed nearby and corresponded to the connector. The labeling unit fastens the rear casing by means of its outer edge. Whereby, the display structure may have function of mass production, convenient assembly and adaption for all kind of connectors.

### FIELD OF THE INVENTION

The present invention relates to a display structure, particularly to the display structure with function of adapting diversified connectors.

### DESCRIPTION OF THE PRIOR ART

Flat Panel Display (FPD) is common appliance in our daily life. Concerning mass production, the manufacture, storage, transportation or supply for components may largely influence the cost, so that these are indeed critical issues for manufactures. Under the trend of centralizing management and production maximization, economic manufacturing and efficient warehousing has become urgent goal need to be settled by those FPD industrials.

In general, the display structure contains circuit board, display panel, backlight module or some other components inside a rear casing. In order to communicate or electrically couple to other external device, the display structure normally has connectors disposed on the circuit board, so as to transmit the electric signals outward.

When distinct display structures are produced, different mold or equipment for rear casings manufacture is indeed required and inevitably, since each type of display structure has its connector arrangement. Therefore it is impossible to reach mass manufacturing maximization as far as possible.

In this scenario, under the condition of small-volume, large-variety production, the competition is therefore devastating and the profit is thus decreased. So how to increase the margin and competition in manufacturing display structure is an urgent problem needed to be resolved.

### SUMMARY OF THE INVENTION

The primary object of present invention is to achieve manufacturing maximization and cost-reduce of a display structure.

Another object of present invention is to assemble the display structure according to the type or the number of the connectors and the labeling unit for which any country is needed.

Yet another object of present invention is to fasten or stick the rear casing and the labeling unit by means of tenon and notch, so as to achieve mechanical strength between joint structures, and thus has merit of easily assembling.

To achieve the foregoing and other objects, a display structure is provided. The display structure comprises a rear casing, a circuit board, at least one connector and a labeling unit. The rear casing is disposed at behind of the display structure. The circuit board is disposed at interior of the display structure. The connector connects to the circuit board. The labeling unit contains at least one fitting hole penetrating the labeling unit. The connector is corresponded to and located inside the fitting hole. Each fitting hole has a labeling figure disposed nearby and corresponded to the connector. The labeling unit fastens the rear casing by means of its outer edge. Whereby, the display structure may have function of mass production, convenient assembly and adaption for all kind of connectors.

In the aforementioned display structure, wherein the connector might be male connector or female connector.

In the aforementioned display structure, wherein the connector might be phone jacket, high definition multimedia interface (HDMI) connector, digital video interface (DVI) connector, video graphics array (VGA) connector, D-type connector, universal serial bus (USB) connector, Mini USB connector, RCA connector, DP connector, 1394 fire wire or PS2 connector.

In the aforementioned display structure, wherein the rear casing has at least one notch corresponded to outer edge of the labeling unit, so as to fasten the labeling unit. The labeling unit further contains at least one tenon disposed at outer edge, so that the notch may fasten the tenon. The tenon is inside the notch by tight fit when the notch fastens the tenon.

In the aforementioned display structure, wherein the labeling unit further contains at least one notch corresponded to the rear casing, so as to fasten the rear casing. The rear casing further contains at least one tenon, so that the notch may fasten the tenon. The tenon is inside the notch by tight fit when the notch fastens the tenon.

In the aforementioned display structure, wherein the labeling unit might be indentation structure.

Whereby, the display structure of present invention may have rear casings mass-produced, so as to achieve manufacturing maximization and cost reduce. Besides, the connectors may be assembled according to the type or the number of the connectors and the labeling unit for which those countries are needed. Moreover, the rear casing and the labeling unit may be fastened or stuck by means of tenon and notch, so as to achieve mechanical strength between joint structures, and thus has merit of easily assembling.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is perspective view diagram of display structure according to the first embodiment of present invention;

FIG. 1B is side view diagram of display structure after assembling according to the first embodiment of present invention;

FIG. 2 is side view diagram of display structure according to the second embodiment of present invention;

FIG. 3 is side view diagram of display structure according to the third embodiment of present invention;

FIG. 4 is perspective view diagram of display structure according to the fourth embodiment of present invention.

### DESCRIPTION OF THE PREFERRED EMBODIMENTS

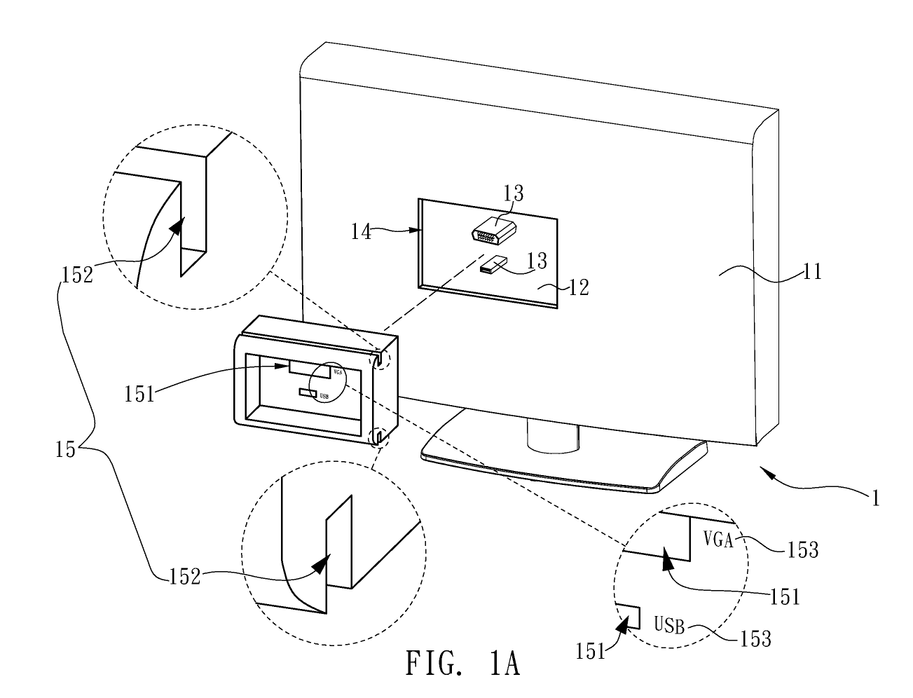

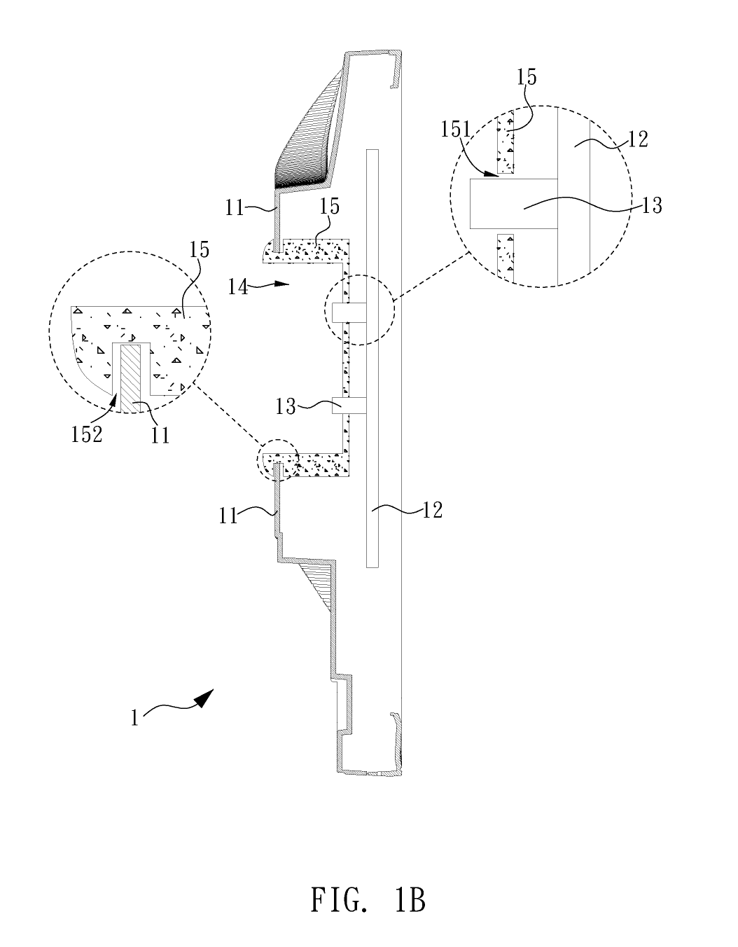

Please refer to FIG. 1A, FIG. 1A is perspective view diagram of display structure according to the first embodiment of present invention. As shown in FIG. 1A, a display structure 1 includes a rear casing 11, a circuit board 12, two connectors 13 and a labeling unit 15. The rear casing 11 is disposed at behind of the display structure 1. The rear casing 11 is hollowed out with a casing hole 14 thereon, wherein the circuit board 12 is disposed inside the display structure 1 and two connectors 13 are disposed on the circuit board 12 so as to couple with the circuit board 12. Therefore the configuration regarding to two connectors 13 and the circuit board 12 inside the casing hole 14 can be seen from outside of the rear casing 11. The labeling unit 15 has two fitting holes 151 penetrating the labeling unit 15, and contains two notches 152 respectively disposed at upper side and lower side of the labeling unit 15. Each fitting hole 151 is corresponded to one connector 13, so that the connector 13 may be passed through and disposed inside the fitting hole 151. The labeling unit 15 is corresponded to the casing hole 14, therefore two notches 152 disposing at upper side and lower side of labeling unit 15 may be corresponded to and fastened to the rear casing 11; i.e. the labeling unit 15 could be disposed in the casing hole 14 and thus might be fitted with the rear casing 11 while moving the labeling unit 15 toward the casing hole 14. In this manner, the labeling unit 15 might be fastened and stuck on the rear casing 11 by means of those notch structures, without releasing and falling off. Moreover, each fitting hole 151 having a labeling FIG. 153 disposed at outer surface of the labeling unit 15 and adjacent to the fitting hole 151, wherein each labeling FIG. 153 is corresponded to a connector 13 for the purpose of identifying this connector 13. In this manner, people may realize the type of the connector 13 by means of reading the labeling FIG. 153, thus it is convenient for assembly workers to install, or for user to plug the jointing cable. Except for labeling function, the labeling unit 15 may also have shielding function, so as to prevent Electromagnetic Interference (EMI) and protect the circuit board 12 from jamming or inadvertently electric shock. In general, the connectors 13 might be male connector or female connector; besides, the connectors 13 might also be phone jacket, high definition multimedia interface (HDMI) connector, digital video interface (DVI) connector, video graphics array (VGA) connector, D-type connector, universal serial bus (USB) connector, Mini USB connector, RCA connector, DP connector, 1394 fire wire or PS2 connector.

Please refer to FIG. 1B, FIG. 1B is side view diagram of display structure after assembling according to the first embodiment of present invention. As shown in enlarged diagram of FIG. 1B, after the labeling unit 15 is fitted to the rear casing 11, the labeling unit 15 may be firmly fastened by means of placing the rear casing 11 inside two notches 152. Meanwhile two connectors 13 may penetrate two fitting holes 151 so as to protrude from the labeling unit 15. In this embodiment, cross-section view of the labeling unit 15 is “U” shaped, so that the rear casing 11 might look like a cave. In this manner, the display structure 1 may have enough space for pulling or plugging a cable (not shown).

In other embodiment, number of the notches 152 disposed at labeling unit 15 may be plurality. Moreover, the notches 152 might be disposed at any outer surface of the labeling unit 15. The rear casing 11 might also further have at least one tenon (not shown) disposed near the casing hole 14, so that the tenon might be corresponded to and fastened to the notch 152 by means of placing the tenon inside the notch 152, so as to achieve tightly fit condition. Therefore the mechanical strength of joint structure between the labeling unit 15 and the rear casing 11 is thus reinforced.

In this manner, the rear casings 11 and the labeling units 15 may be manufactured respectively and separately, for example, the rear casings 11 are mass produced in one country and then the labeling units 15 are produced with small amount in several other countries according to the type or the number of the connectors 13 for which those countries are needed. In this manner, if size of the display structure 1 is determined, then one specific type of rear casing 11 may go with diversified connectors 13 and labeling units 15. Thus it may have merits of manufacturing rear casing 11 with maximization and lowering cost. Besides, the means of fastening and fitting for the rear casing 11 and the labeling unit 15 may have function of easily assembling.

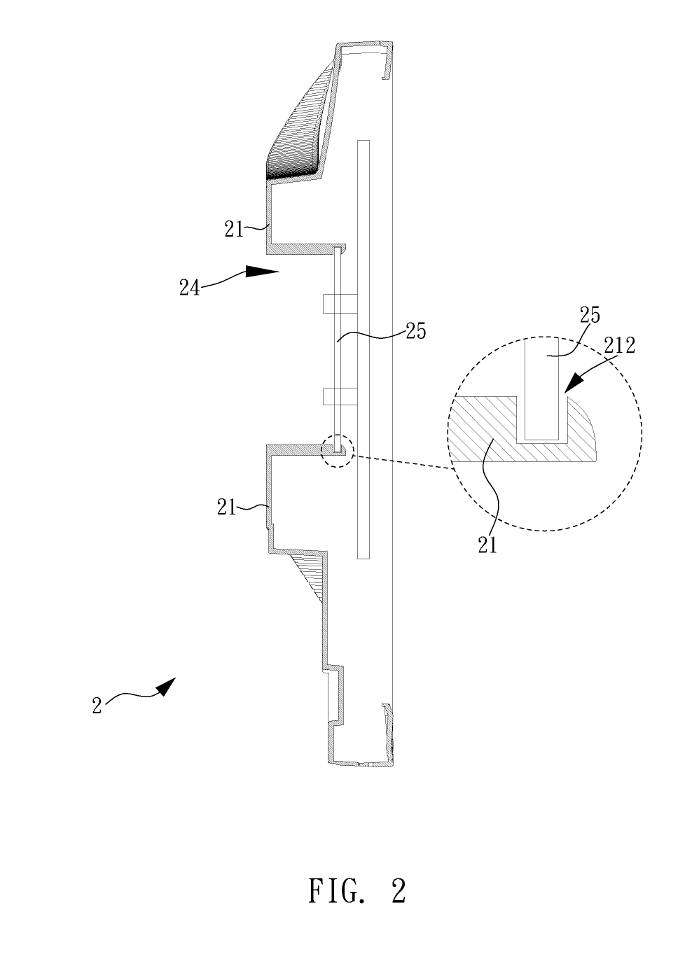

There are some other embodiments remained. Please refer to FIG. 2, FIG. 2 is side view diagram of display structure according to the second embodiment of present invention. As shown in FIG. 2, the rear casing 21 of display structure 2 is concave structure and the labeling unit 25 is plate structure. Two notches 212 disposing above and beneath the casing hole 24 of rear casing 21 may be corresponded to and fastened to upper side and lower side of the labeling unit 25 respectively. In some other embodiments, the labeling unit 25 might further have at least one tenon (not shown) disposed at its upper side and lower side, so that the tenon might be corresponded to and fastened to the notch 212 with tightly fit. In this manner, the mechanical strength of joint structure between the labeling unit 25 and the rear casing 21 is thus reinforced. Thus the previous advantages set forth aforementioned could also be achieved.

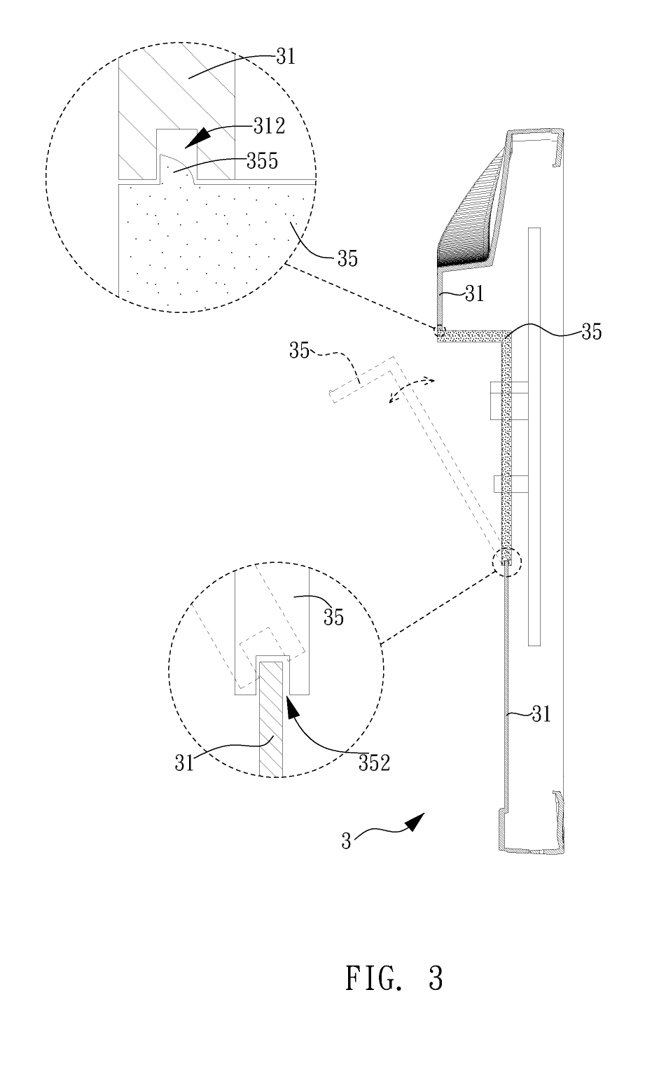

Please refer to FIG. 3, FIG. 3 is side view diagram of display structure according to the third embodiment of present invention. As shown in FIG. 3, there is an altitude difference between upper half and lower half of the rear casing 31, therefore labeling unit 35 the display structure 3 may be L-shaped. As shown in upper enlarged diagram of FIG. 3, the labeling unit 35 has a tenon 355 disposed above, and the rear casing 31 has a notch 312 disposed at lower side and corresponded to the tenon 355. As shown in lower enlarged diagram of FIG. 3, the labeling unit 35 has a notch 352 disposed at lower side, and then the notch 352 may be corresponded to and fastened to the rear casing 31. In preferable case, the labeling unit 35 may be clockwise rotated around the notch 352 so as to be installed. In this manner, the tenon 355 above labeling unit 35 may enter the notch 312 of rear casing 31 by means of flexibility of the labeling unit 35, so as to achieve fastened and matched fashion.

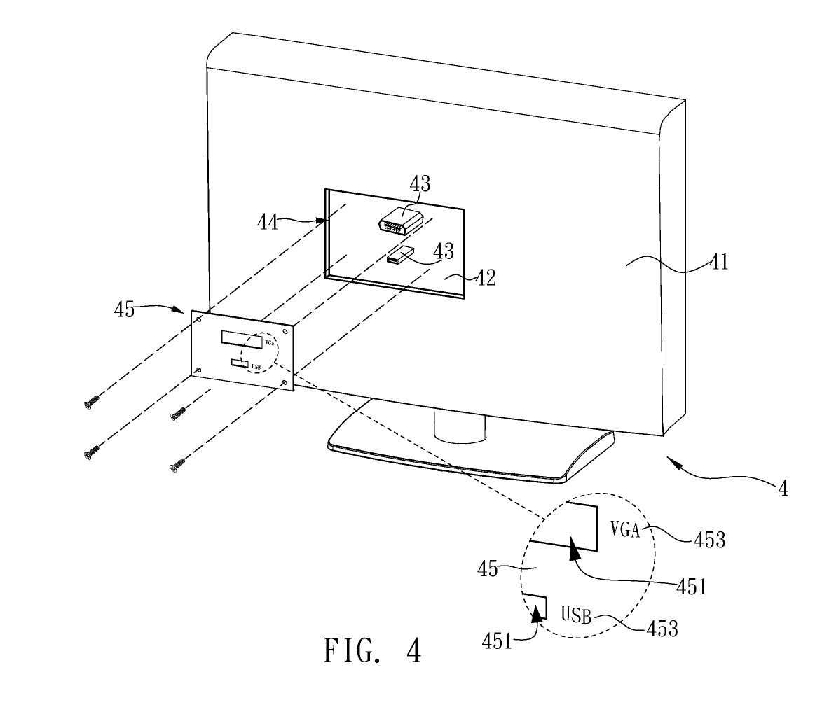

Besides, the labeling unit might also have another sticker or other attached mask. Please refer to FIG. 4, FIG. 4 is perspective view diagram of display structure according to the fourth embodiment of present invention. As shown in FIG. 4, the display structure 4 includes a rear casing 41, a circuit board 42, two connectors 43, a casing hole 44 and a labeling unit 45; wherein similar configuration is not described again. In this embodiment, the labeling unit 45 could be a film or thin plate with material of tinplate or plastic, thus the labeling unit 45 may have function of shielding. The labeling unit 45 further contains two labeling FIG. 453 and two fitting holes 451 correspond to two connectors 43 respectively. Two labeling FIG. 453 could be marked, stuck or painted near the fitting holes 451. Thus the labeling unit 45 may be attached to and installed on the circuit board 42 directly, so that the connectors 43 could penetrate the fitting holes 451. Additionally, the labeling unit 45 may be combined with the circuit board 42 by means of several screws, glue or some other adhesive manners.

Summarily, the display structure of present invention may have rear casings mass-produced, so as to achieve manufacturing maximization and cost reduce. Besides, the connectors may be assembled according to the type or the number of the connectors and the labeling unit for which those countries are needed. Moreover, the rear casing and the labeling unit may be fastened or stuck by means of tenon and notch, so as to achieve mechanical strength between joint structures, and thus has merit of easily assembling.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A display structure, comprising:
a rear casing disposed at behind of the display structure;
a circuit board disposed at interior of the display structure;
at least one connector connected to the circuit board;
a labeling unit containing at least one fitting hole penetrating the labeling unit, the connector being corresponded to and located inside the fitting hole, each fitting hole having a labeling figure disposed nearby and corresponded to the connector, the labeling unit fastening the rear casing by means of its outer edge;
whereby the display structure may have function of mass production, convenient assembly and adaption for all kind of connectors.

2. The display structure as claim 1, wherein the connector might be male connector or female connector.

3. The display structure as claim 1, wherein the connector might be phone jacket, high definition multimedia interface (HDMI) connector, digital video interface (DVI) connector, video graphics array (VGA) connector, D-type connector, universal serial bus (USB) connector, Mini USB connector, RCA connector, DP connector, 1394 fire wire or PS2 connector.

4. The display structure as claim 1, wherein the rear casing has at least one notch corresponded to outer edge of the labeling unit, so as to fasten the labeling unit.

5. The display structure as claim 4, wherein the labeling unit further contains at least one tenon disposed at outer edge, so that the notch may fasten the tenon.

6. The display structure as claim 5, wherein the tenon is inside the notch by tight fit when the notch fastens the tenon.

7. The display structure as claim 1, wherein the labeling unit further contains at least one notch corresponded to the rear casing, so as to fasten the rear casing.

8. The display structure as claim 7, wherein the rear casing further contains at least one tenon, so that the notch may fasten the tenon.

9. The display structure as claim 8, wherein the tenon is inside the notch by tight fit when the notch fastens the tenon.

10. The display structure as claim 1, wherein the labeling unit might be indentation structure.
